(19) United States
(12) Patent Application Publication
(10) Pub. No.: US 2018/0079175 A1
(43) Pub. Date: Mar. 22, 2018

(54) COATED STEEL PARTS AND PRODUCTION METHODS THEREOF

(71) Applicant: Alberto Manuel Ontiveros Balcazar, Zapopan, Jalisco (MX)

(72) Inventor: Alberto Manuel Ontiveros Balcazar, Zapopan, Jalisco (MX)

(21) Appl. No.: 15/563,555

(22) PCT Filed: Mar. 30, 2015
(86) PCT No.: PCT/MX2015/000056

§ 371 Date: Sep. 29, 2017

(51) Int. Cl. B32B 15/04; H01B 1/02; H01R 4/66; H01R 13/03; C23C 22/76

(52) U.S. Cl. CPC B32B 15/043; H01B 1/02; H01R 4/66; H01R 13/03; B32B 2250/03; B32B 2311/30; B32B 2313/04; B32B 2311/20; B32B 2311/12; C23C 22/76

(57) ABSTRACT

The present invention relates to a carbon steel part coated with a coating of multiple layers of various materials, such as zinc, copper, and tin, and a sealing coating based on a product known commercially as Solderex TB-Br. The part can be used to produce conductors and electrodes which receive and carry electricity and which can, in turn, form part of an electrical energy control system. The present invention also relates to a method for coating a carbon steel part with a coating of multiple layers of various materials, wherein said method comprises: applying a zinc layer coating the surface of a carbon steel support material; applying a copper layer on the zinc layer; applying a tin layer on the copper layer; and applying a sealing layer on the tin layer.

### TECHNICAL FIELD OF THE INVENTION

The present invention is in the technical fields of chemistry, electricity, mechanics and protection against electrical discharges, since it relates to coated steel parts with enhanced properties of electric conduction, short circuit capacity, corrosion resistance and protection against electrical discharges. More particularly, the invention relates to a coated malleable steel part with a coating of multiple layers of various materials, which can be used as conductors and grounding electrodes for electrical energy control systems.

### BACKGROUND OF THE INVENTION

Currently, steel products coated with tin, to give them greater corrosion resistance, are well known. For example, there is tinplate, which is made of a steel base providing rigidity to the material due to its thickness and mechanical strength. Moreover, its chemical composition gives it special properties that increase its corrosion resistance.

Similarly, there are iron-tin alloys comprised of the intermetallic compound Fe—Sn2, which by its electrochemical characteristics acts as a barrier against corrosion. There are also coatings of metallic tin, which is one of the most important element in protecting steel used for containers.

On the other hand, there are the passivation films, which, according to their nature, allow improving the resistance of tinplate to sulfation, oxidation and rust, as well as oil film, which protect the plate from moisture in the air and facilitate its handling and are applied by an electrostatic oiler on both sides of the sheet or part to be treated.

In particular, tin-plating is an acid process through electrolysis that deposits very shiny tin layers both in frame as in drum, on materials such as aluminum and its alloys, copper and its alloys, stainless steel and carbon steel. Tin-plating is pursued because it provides a shiny appearance, good conductivity and weldability.

Based on the above, it was found that patent document ES2171003 describes a substrate and part with a coating to protect against corrosion in a briny atmosphere, which comprises at least one layer of a zinc-nickel alloy containing 8-35% by weight of zinc and a sublayer of a zinc-nickel alloy containing 10-16% by weight of nickel. The sublayer is between the metal part and the layer of tin-zinc alloy, with the ratio of the thickness of the coatings of the two alloys is two-thirds for the zinc-nickel alloy and one third for the zinc-tin alloy.

For its part, patent document ES2302313 discloses a hot-dip galvanizing bath for parts in any kind of steel, especially parts in silicon and/or phosphorus steel, which have first undergone pretreatment in the form of degreasing, pickling acid and flux, which is composed of a zinc alloy comprising bismuth, tin, vanadium, manganese and aluminum.

Similarly, patent application JP2013087339 describes a method for producing a tin-plated steel strip, where a steel strip undergoes an electrolytic tin coating, in which the coating bath contains 10-80 g/L of tin ions, 15-70 g/L of free methanesulfonic acid, 0.1-10 g/L of a polishing agent, and 0.1-5 g/L of an antioxidant.

Another patent document, U.S. Pat. No. 3,869,261, discloses an article that comprises a steel base and a corrosion-resistant coating, where the coating has been obtained through a three-layer structure on the surface of the steel material. This structure consists of: (i) a zinc electroplated inner layer (5-μm), (ii) a copper electroplated middle layer (6 μm), and (iii) a tin electroplated outer layer (6 μm), thus forming a layer of copper-tin alloy between the middle and outer layers through heat treatment of the three layers.

This document U.S. Pat. No. 3,869,261 also describes a method for forming a multi-layer, corrosion-resistant coating on a steel material. This method comprises: (i) galvanizing the surface of the steel with zinc, with an electrowinning liquid consisting of 258 g/L of zinc sulfate, 11.2 g/L of aluminum chloride, and 75 g/L of sodium sulfate, with a pH of 4.5, with stirring of the liquid at 50° C. with a cathode current density of 50 A/dm² for 37 s; (ii) forming a copper electroplated layer on the zinc layer by dipping the steel material coated with zinc in an aqueous solution containing 2% nitric acid to activate the surface of the zinc layer, and the electrowinning liquid is 120 g/L of copper cyanide, 130 g/L of sodium cyanide and 25 g/L of caustic soda, with a pH of 12.5, with stirring at 55° C. and a cathode current density of 8 A/dm² for 140 s, where the thickness of the copper layer is 6 μm; (iii) forming a tin electroplated layer over the copper layer by immersing the steel material of the previous step for several seconds in an aqueous solution of 2% nitric acid to activate the surface of the copper layer and then forming the tin electroplated layer 6μm thick, where the electrowinning liquid was 42.2 g/L of tin sulfate with a pH of 1-4, with stirring of the liquid, and with a cathode current density of 15 A/dm² for 50 s; and (iv) heat treatment of the multilayer coating to obtain a middle layer of alloy between the copper and tin layers; while, to this end, the article with the three layers was passed at a speed of 2 mm/s in an electric oven with an inside temperature of 288° C., thus obtaining a uniform corrosion-resistant multi-layer coating, where the thickness of the copper layer is 3 μm or more and the heat treatment of step (iv) is carried out in a gaseous phase or in an oil layer at a temperature around the melting point of tin but without the temperature of the outer layer exceeding the melting point of tin.

That document U.S. Pat. No. 3,869,261 shows that the thickness of the coating after the heat treatment is 18 μm, which is thinner than the initial thickness of 20 μm. The resulting tin layer was 1.15 μm thick, the layer of copper-tin alloy was 11.68 μm thick, the zinc layer was 5.17 μm thick, and the layer of zinc-copper alloy was very thin in thickness and could only be seen with a microscope. An example of the steel material used was a mild steel tube. With regard to the results achieved when the coated steel article was tested for corrosion resistance, it was noted that steel articles coated with three layers (zinc, copper, and tin), with and without heat treatment, had excellent corrosion resistance.

However, all the abovementioned products only have the advantage of being more resistant to corrosion or the environment, but none of these types of steel are capable of being used as grounding electrodes to produce electrical energy control systems. This is because such corrosion resistance, although higher due to the tin coating, is not enough to resist the corrosion underground to which grounding electrodes are subjected. In addition, their capacity to conduct electricity is very poor.

In this sense, usually the material used to manufacture grounding electrodes, to produce electrical energy control systems, is copper, due to its high corrosion resistance underground and in the environment and due to being a very good conductor of electricity. However, the copper is not only an excellent material to manufacture grounding electrodes but also to manufacture many other products of basic necessity, either alone or alloyed with other metals.

For this reason, copper is a material that is expensive and in great demand, which leads to its constantly being stolen and resold on the black market. This is a big problem, since the theft of electrodes or cables not only results in economic losses but also failure of the electrical power supply essential for operating hospitals, clinics, airports, etc., which creates another set of problems already known. In the same way, the theft of grounding electrodes causes problems when electrical or communication towers receive a thunderbolt in the rainy or stormy season, because the energy thereby generated has no way of being dispelled, causing the equipment to burn out and many other problems like those already mentioned.

Therefore, the state of the art does not have parts or strips of malleable steel with a coating of a plurality of layers of various materials for use as grounding electrodes, where such a coating is carried out in a single procedure.

With a view to countering the abovementioned disadvantages, a steel part with a coating of multiple layers of metallic materials was manufactured, to prolong its useful life and give corrosion resistance but without affecting its electrical conductivity. Consequently, such coated carbon steel parts can be used as grounding electrodes to produce electrical energy control systems. Also, a method was developed for manufacturing these coated steel parts.

### OBJECTS OF THE INVENTION

Therefore, one object of this invention is to provide a coated malleable steel part for use as conductors and/or grounding electrodes.

Another object of the invention is to provide a coated malleable steel part that has 50% more useful life than conventional coated steel or copper strips or parts.

Another object of the invention is to provide a coated malleable steel part that has a short circuit capacity 30-100% greater than conventional steel or copper strips.

Yet a further objective of the present invention is to provide a coated malleable steel part that reduces by 60% the use of material for grounding electrodes.

An additional object of the invention is to provide a coated malleable steel part that can be can be welded without the use of clamps.

An additional object of the invention is to provide a coated malleable steel part that reduces by 10-30% the exothermic welding material and the installation time of a grounding line by 40-60%, since the length of the ditches where it is installed is substantially reduced compared to the use of copper cable, thus achieving a great saving of manpower.

Yet another object of the invention is to provide a malleable coated steel part made of a material that is not susceptible to theft, because its copper content is very low and it is not copper-colored.

Still another object of the present invention is to provide a coated malleable steel part that has very high corrosion resistance and a great capacity to conduct electricity.

A further object of the present invention is to provide a coated malleable steel part that, due to its electrochemical potential, is compatible when interconnected with both copper and aluminum.

Yet an additional object of the present invention is to provide a coated malleable steel part with different uses or applications, taking advantage of this malleability to easily stamp and/or deeply engrave it and thus to be able to identify the material by; its trademark, characteristics, properties, owner's name, batch and/or identification number, etc, in such a way that the data that is engraved on this material is not easily erased.

The invention also aims to provide a grounding conductor and/or electrode for electrical energy control systems, where the conductor and/or electrode is made of at least one aforementioned coated steel part.

Therefore, the invention also aims to provide a production method for the aforementioned coated steel part.

Additional characteristics and advantages of the present invention are understood more clearly through the detailed description of the preferred implementation of the same, given by way of example and not meant to be exhaustive, with reference to the attached drawings, in which:

### BRIEF DESCRIPTION OF THE DRAWINGS

FIG. 1 compares some carbon steel strips without any coating kept in a salt spray chamber, at 0 and 200 h.

FIG. 2 illustrates the behavior of carbon steel strips coated with a film of NOX-RUST® wax, kept in the salt spray chamber for 200 h,

FIG. 3 illustrates the behavior of carbon steel strips coated with CRC® Cold Galvanizing Paint, kept in the salt spray chamber for 200 h.

FIG. 4 illustrates the behavior of carbon steel strips with two coatings, CRC® and NOX-RUST®, kept in the salt spray chamber for 200 h.

FIG. 5 illustrates the behavior of carbon steel strips coated with GALVANITE® Cold Galvanizing Paint, kept in the salt spray chamber for 200 h.

FIG. 6 illustrates the behavior of carbon steel strips with two coatings with GALVANITE® and NOX-RUST®, kept in the salt spray chamber for 200 h.

FIG. 7 illustrates the behavior of the galvanized carbon steel strips, kept in the salt spray chamber for 200 h.

FIG. 8 illustrates the behavior of carbon steel strips galvanized and coated with a film of NOX-RUST® wax, kept in the salt spray chamber for 200 h.

FIG. 9 illustrates the behavior of carbon steel strips galvanized and coated with tin, kept in the salt spray chamber for 200 h.

FIG. 10 illustrates the behavior of carbon steel strips galvanized and with two coatings of tin and a coating of NOX-RUST®, kept in the salt spray chamber for 200 h.

FIG. 11 illustrates the behavior of galvanized EDDS 0.02% carbon steel strips, kept in a salt spray chamber for 200 h.

FIG. 12 illustrates the behavior over 200 h of an EDDS 0.02% carbon steel strip coated with a layer of NOX-RUST® wax.

FIG. 13 illustrates the behavior over 200 h of an EDDS 0.02% carbon steel strip coated with a layer of tin.

FIG. 14 illustrates the behavior over 200 h of a galvanized EDDS 0.02% carbon steel strip with a copper coating, a tin coating, and a coating of Solderex TB-B according to the present invention.

FIG. 15 is a schematic diagram of a cross-section of the steel part with a coating of multiple metal layers according to the present invention.

FIG. 16 illustrates the behavior of short circuit current in carbon steel parts coated with multiple metal layers.

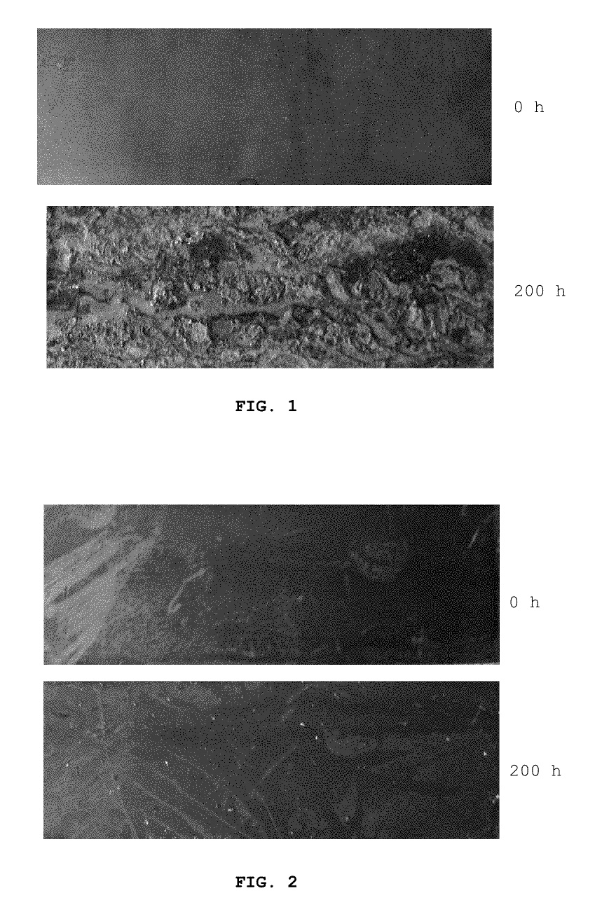

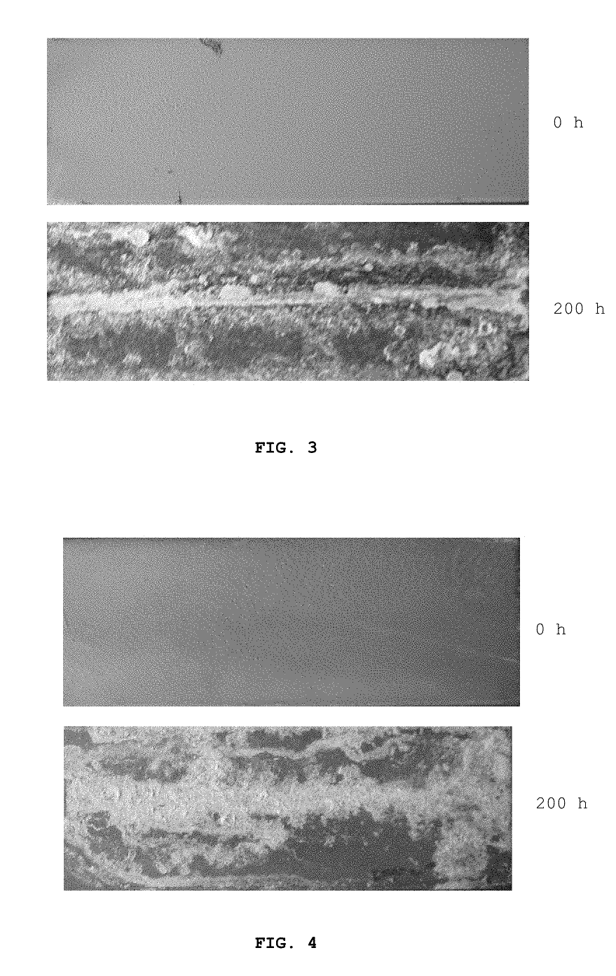

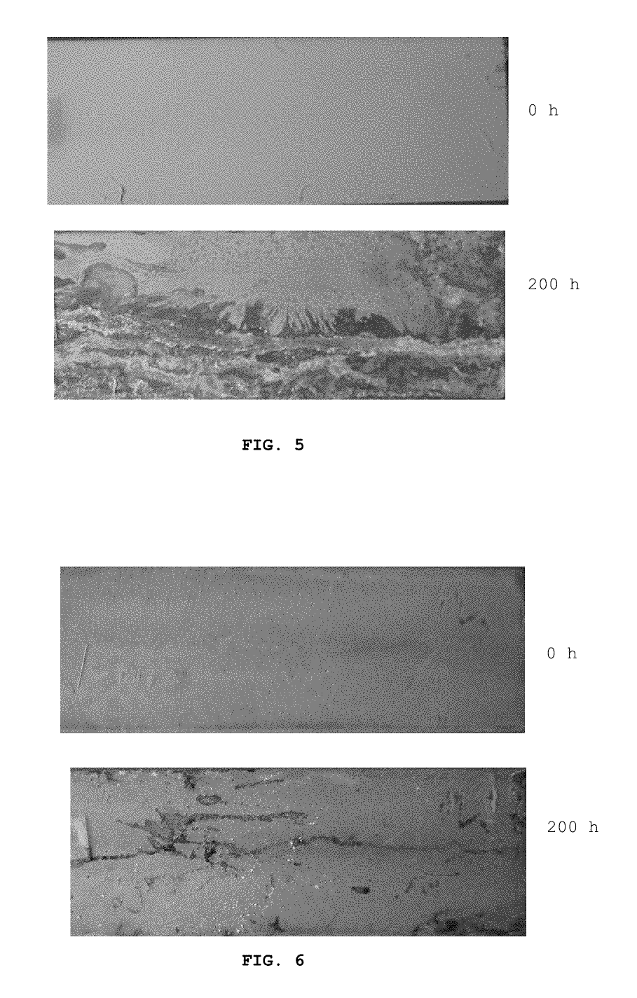

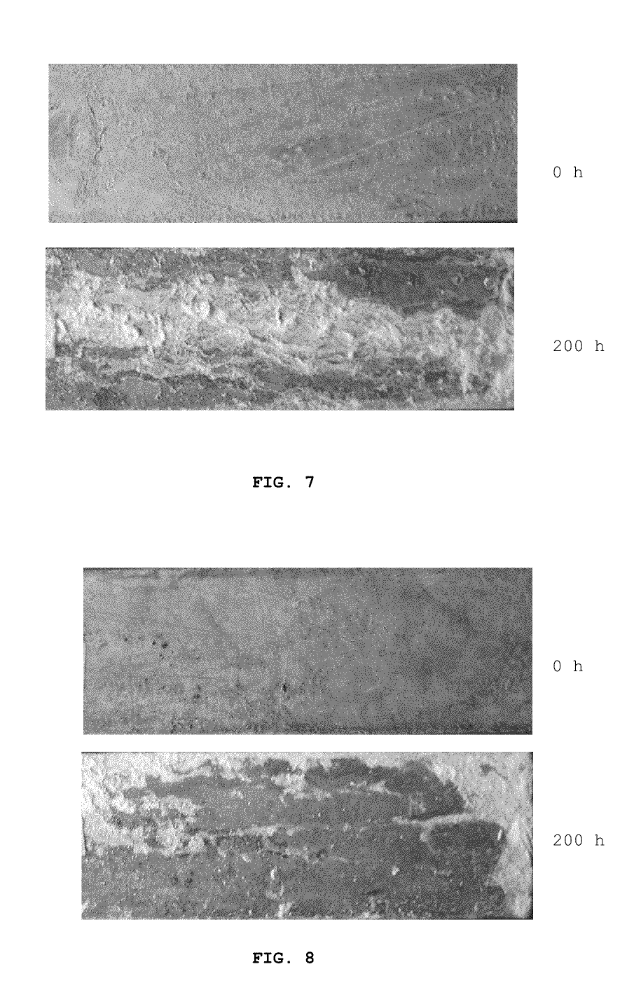

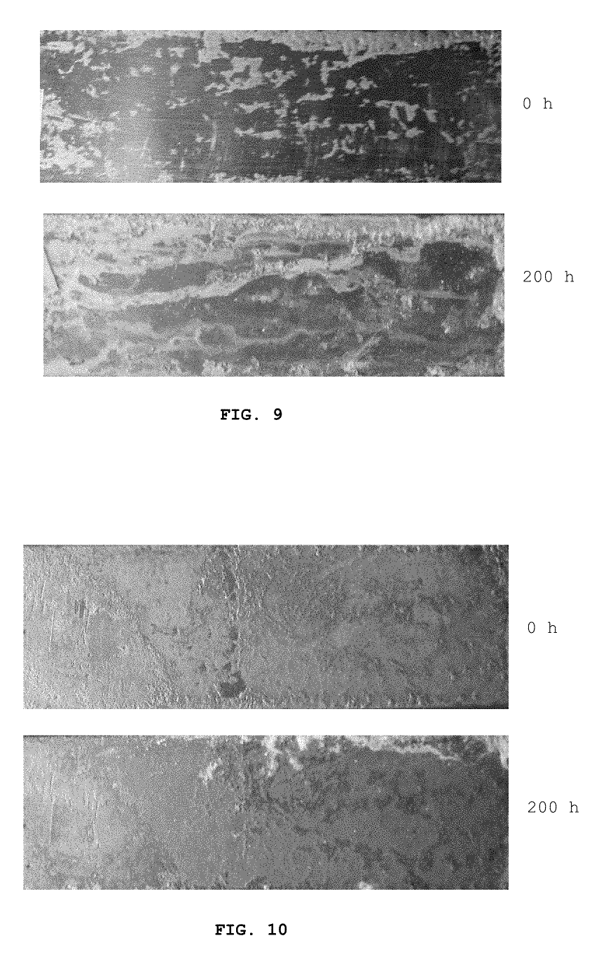

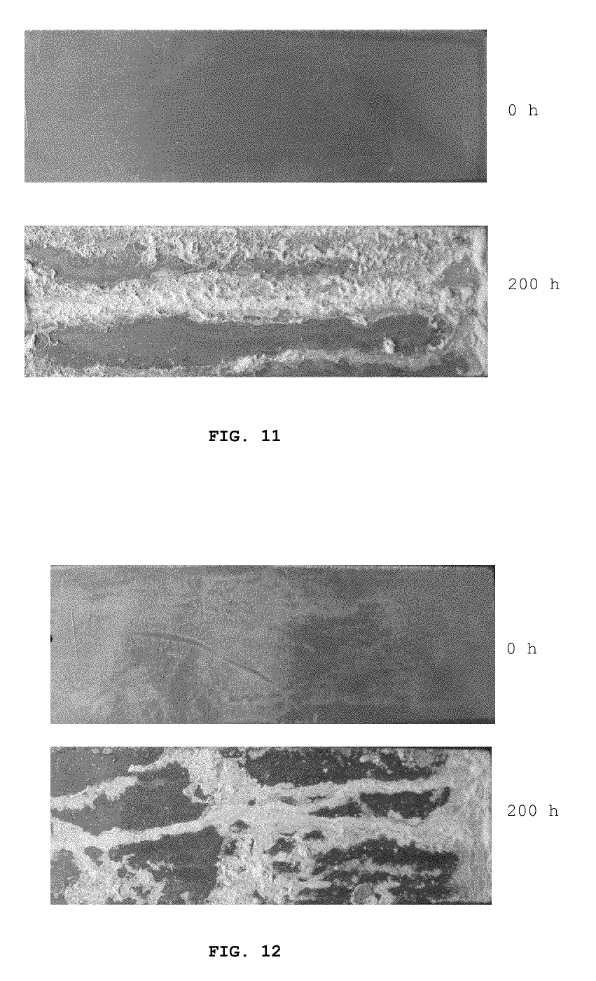

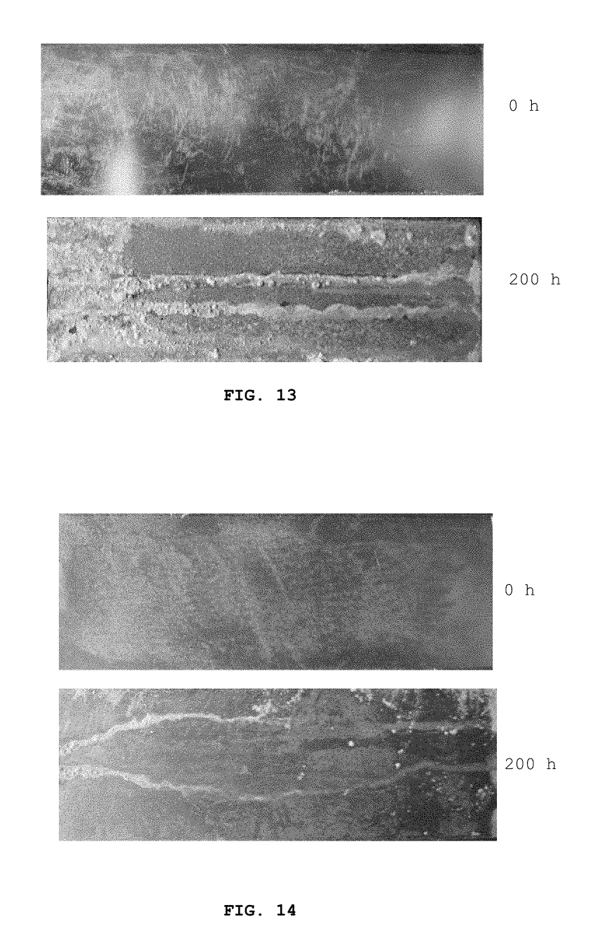

### DETAILED DESCRIPTION OF THE INVENTION

In the first instance, the present invention relates to coated malleable carbon steel parts that are corrosion-resistant and have a very good electrical conductivity, so that they can be used without any problem as electrodes in various electrical energy control systems.

In this respect, it is important to note that the terms “steel parts” and “carbon steel parts” will be understood to include any type of carbon steel parts, such as strips, wires, wire rods, lines, plates, foils, rods, and bars, to name a few by way of example and not meant to be exhaustive.

In one of the modes of the invention, carbon steel strips with a substantially rectangular cross-section and having a surface electrical conductivity of at least 28% IACS are preferred, which is allowed by the electricity specifications. Consequently, these parts can be designed to be used as electrodes for electrical energy control systems, among other applications.

However, with reference to FIG. 15, the coated malleable steel strip according to the present invention is shown. In the first place, there is a steel strip that contains 0.002-0.80% carbon (1) as the support material selected from Table 1 and that has a surface electrical conductivity of at least 28% IACS, which must have the properties: exothermic welding is well accepted, its degree of hardness is not very high, that is, it is malleable, and its installation in the field is not very difficult.

According to Table 1, the preferred steel strip is EDDS (Extra Deep Drawing Steel). However, additional modes can also be DDS parts (Deep Drawing Steel Types A and B).

TABLE 1
Physical tests performed on different types of carbon steel.

| Type of steel | | Exothermic | | Field |
|---|---|---|---|---|
| Name | % C | welding | Hardness | installation |
| CSA | 0.1-0.35 | Failure sometimes | Very Hard | Very difficult |
| CSB | 0.02-0.15 | Failure sometimes | Very Hard | Very difficult |
| CSC | 0.08 | Failure sometimes | Very Hard | Very difficult |
| FSA | 0.1 | Accepted | Very Hard | Very difficult |
| FSB | 0.02-0.1 | Accepted | Hard | Very difficult |
| DDSA | 0.08 | Accepted | Hard | Difficult |
| DDSB | 0.02 | Accepted | Hard | Difficult |
| EDDS | ≥0.02 | Accepted | Very malleable | Very easy |

CS = commercial steel type A, CS8 = commercial steel type B, CSC = commercial steel type C, FSA = forming steel type A, FSB = forming steel type B, ODSA = deep drawing steel type A, DDSB = deep drawing steel type B, EDDS = extra deep drawing steel.

The parts chosen must be 16 gauge (1.5 mm thick), although this gauge or thickness can vary depending on the size of the electrical energy control system.

This coated steel strip according to the present invention comprises a coating, which is made of a plurality of layers, where the first layer is zinc (2) with a thickness of 18-40 μm due to commercial viability and a pressure resistance of 275 g/m², applied by any electroplating method known to the state of the art and using a galvanizing mixture that comprises zinc, preferably as required by standard A653/A653M-10.

Although in the preferred mode a zinc layer with the aforementioned thickness and pressure resistance is preferred, those thicknesses and pressure resistances that provide the technical effects sought by this invention are not rejected.

It is also important to mention that it is better if the galvanizing process is under vacuum, whereby accelerated aging of the strip is reduced.

The second layer is a layer of copper nanoparticles (3) with a thickness of 7-20 μm, applied on the zinc layer by an electrolytic process.

This coating also comprises a third layer (4), where this third layer is a tin layer with a thickness of 7-20 μm, applied on the second layer by an electrolytic tin-plating process. This tin layer is composed of an acid tin-plating mixture comprising: 18.75-37.5 g/L of tin sulfate, 9-10 v/v % of sulfuric acid, 2-4 v/v % of a commercial product known as Solderex TB-A®, and 0.5-0.75 v/v % of a commercial product known as Solderex TBB®.

This coated steel strip comprises, in addition, a coating (5) on the multi-layer coating with a commercial product called Solderex TB-B® (Enthone-OMI de Mexico). This coating acts as a seal and helps to reduce corrosion of this coated strip, which results in its greater durability. The thickness of this coating is less than 1 μm.

Therefore, a preferred mode of the present invention is a carbon steel part that has: a carbon steel support material (1), a zinc layer (2) applied to the surface of the support material, a copper layer (3) applied to the zinc layer, a tin layer (4) applied on the copper layer, and a sealing layer (5) of a commercial product called Solderex TB-B® (Enthone-OMl de Mexico) applied on the tin layer. However, another preferred mode of the present invention is also a carbon steel part that only has: a carbon steel support material (1), a zinc layer (2) applied to the surface of the support material, and a copper layer (3) applied to the zinc layer.

With the coated malleable steel parts according to the present invention, there are many advantages that are not obtained with strips, cables, rods or parts made with conventional materials with or without coating. Among these advantages are a 50% longer useful life than conventional cables or rods made of steel or copper and a short circuit capacity 30-100% greater than conventional cables or rods, because the melting point of steel is over 1500° C., where such resistance is directly proportional to the gauge (thickness) of the strips.

Also, parts according to the present invention reduce by 60% the use of material for grounding electrodes, because they have a greater contact surface than conventional cables or rods. In addition, parts according to the present invention can be welded together without using clamps, which reduces by 10-30% the exothermic welding material, and the installation time of a grounding line by 40-60%.

In the same way, another advantage of coated parts according to the present invention is the total reduction of the theft of lines or cables, since the material and the coating with which they are made do not have commercial value on the black market. In addition to the fact that parts according to the present invention have a final tin layer, it gives them an electrochemical potential that is compatible for interconnecting with both copper and aluminum. So there will be no galvanic couple problems.

Finally, the coated malleable steel strips according to the present invention, due to the various materials of their coating, are likely to have multiple uses or applications that are not achieved with conventional wires or rods.

Another aspect of the present invention relates to a method to coat carbon steel parts with a coating of multiple layers of various materials. Such a procedure can be started from the step of submitting the steel part to a galvanizing process to apply a first layer, which is zinc, with a thickness of 18-40 μm and a pressure resistance of 275 g/m².

In one mode, this procedure can dispense with the stage of applying the zinc layer, because the part can be obtained commercially already coated with a zinc layer.

Then proceed to degrease by immersion, for carbon steel metal parts that already have a zinc coating, with an alkaline cleaner that removes grease and oils on all types of metals except aluminum. The alkaline cleaner can be based on sodium hydroxide (caustic soda); whose use is recommended at a concentration of 5-10%, the optimum being 7.5%, within a temperature range of 60-70° C.; dipping the parts for 1-15 min, preferably within a range of 1-3 min. To prepare the cleaner mixture, a mild steel tank is appropriate, filled to 2/3 of its volume with water. Slowly add the required amount of alkaline cleaner with constant stirring. Add water to fill the tank to its operating level and heat to operating temperature.

Now degrease by spraying with an alkaline cleaner with high detergency and low foaming, suitable for spraying and that can be used to clean steel, copper, brass, magnesium, aluminum, and other metals. This is achieved by spray rinsing the metal parts with a mixture of plain water and alkaline cleaner, for example, the product known as EMPREP SP68, at a concentration of 15-30 g/L, at room temperature and for a sufficient length of time to clean off loosened oil and grease residues.

Spray rinse the metal parts with plain, unprocessed water at room temperature and for a sufficient length of time to clean off loosened oil and grease residues as well as at least 90% of the alkaline cleaner.

Activate the metal parts in question by immersion in an acid salt solution, preferably an acid salt that replaces muriatic or sulfuric acid and is recommended for electrowinning cycles, as a neutralizer leaving surfaces free of ashes or any other dust contaminant. The recommended solution is 15-30 g/L at room temperature for 1-5 min of immersion of the parts. With this activation, the carbon steel parts do not experience wear from the copper bath and are prepared to receive it. The salt acid thereby produces a corrugated outer surface on the previously galvanized carbon steel part, which facilitates the adherence of the copper particles that are then applied by electrolysis. An example of an activator product is the one known commercially as Actane 73®.

Spray rinse the metal parts with plain, unprocessed water at room temperature for a sufficient length of time to clean off activator residues.

Apply a layer of copper nanoparticles by electrolysis, with an aqueous mixture of 60 g/L of sodium cyanide, 45 g/L of copper cyanide, and a liquid additive agent for electroplating solutions, for example, 20 g/L of Rocheltex® salt, at 40-50° C., pH of 11-12, for 10-15 min, 4-6 amp, whereby electrowinning of a copper layer of 7-20 μm is achieved. This copper layer is for the purpose of giving the parts greater corrosion resistance and a better finish, because the tin adheres better.

Subject the copper-plated steel metal parts to two continuous spray rinses with plain, unprocessed water at room temperature for a sufficient length of time to clean off residues left by the copper-plating solution.

In one mode, the method concludes here, when it is desired to manufacture a carbon steel part with only a coating of two layers: a zinc layer and a copper layer. However, when it is desired to manufacture make a carbon steel part with a coating of four layers (zinc, copper, tin, and sealant), the procedure comprises the stages described below.

To activate the surface of the copper coating of the steel parts, these are dipped in an aqueous solution of a fluoride acid salt, for example, Actane 73®, whose CAS number is 16984-48-8, at a concentration of 30 g/L and at room temperature for 1-5 min. This helps to “open ” the copper molecule to increase the adherence of the tin.

Subsequently, the copper-plated steel parts are spray rinsed with water for a sufficient length of time to clean off the activator residues.

Subject the zinc-plated and copper-plated carbon steel part to acid immersion tin-plating with a mixture that comprises 18.75-37.5 g/L of tin sulfate, 9-10 v/v % of sulfuric acid, 2-4 v/v % of a commercial product known as Solderex TB-A®, and 0.5-0.75 v/v % of a commercial product known as Solderex TBB®; at a temperature of 16-27° C., with a cathode current density of 0.5-4 ASD (drum) and 0.5-3 ADS (barrel), with an anode current density of 1-3 ASD, for an immersion time of 10-15 min, until a tin layer with a thickness of 7-20 μm is deposited on the outer surface of the galvanized and copper-plated steel part.

Then rinse the metal parts with deionized water at room temperature until excess tin particles that have not adhered to the parts are eliminated.

Activate the already tin-plated parts by dipping them in a solution containing a fluoride acid salt to neutralize the action of tin, for example, Actane 73® whose CAS number is 16984-48-8, at room temperature for 1-5 min, to prevent the part from staining and acquiring greater shine.

The parts are spray rinsed with “plain raw” (unprocessed) water at room temperature for a sufficient length of time to clean off activator residues.

Seal the tin-plated and clean steel metal parts by immersion rinsing in a solution that helps the acid tin components not to leave yellow spots or to make the holes on the corrugated outside surface of the tin-plated steel parts difficult to rinse. For example, an aqueous solution containing the commercial product Solderex TBB® at a concentration of 0.5-0.75 v/v % can be used at a temperature of 21° C. for 15-60 min, although around 25 min is preferred, until achieving a sealant layer of no more than 1.

With this immersion rinsing, an outer layer is added to the carbon steel parts already copper-plated and tin-plated, which is like a seal that helps reduce corrosion to these parts, since the Solderex TB-B particles adhere in those pores, micropores, and cracks that are left in the tin layer.

Finally, the metal parts are subjected to air drying at room temperature in order to dry them and prepare them for packaging or direct use.

To perform this procedure, any equipment, vat, machine, etc., can be used, among those conventionally known, which can be adapted for this purpose, either separately or continuously. In this way, with the procedure to coat steel parts according to the present invention, we obtain carbon steel parts (1) with a coating of multiple layers of various materials; where the first layer is zinc (2), with a thickness of 18-40 μm, the second layer is copper (3) with a thickness of 7-20 μm, the third layer is tin (4) with a thickness of at least 7-20 and the fourth layer is of a commercial product Solderex TBB® (5) with a thickness of no more than 1.

Although in the preferred mode the coated carbon steel metal part obtained by the procedure according to the present invention is to a metal strip with a substantially rectangular cross-section, in alternative modes this metal part can be a line, rod, bar, wire, wire rod, plate, foil, dart, among others, without departing from the scope of the present invention.

Among the uses or applications that can be used parts coated carbon steel according to the present invention are:

### Conductors and Electrodes for Conducting Electrical Power

In this invention, the coated carbon steel parts obtained with the procedure described above can be useful for various things such as conductors and/or electrodes for conducting electricity, where this conductor and/or electrode can be simple, that is, a single coated carbon steel metal part, or more than one part and joined linearly or branched.

To join two tin-plated carbon steel strips according to the present invention, a connector is not required, so that the joining with exothermic welding is direct.

Therefore, these conductors and electrodes fall under the protection of the present invention.

### Grounding System

With the conductors and electrodes described above, which in turn are made of at least one coated carbon steel metal part, may be part of a conventional grounding system; where this conductor and electrode can be installed outdoors or in the ground, ensuring that it will have a durability of more than 45 years outdoors and in the ground. It can also be installed in any piece of ground, regardless of the electrical resistance of the ground.

This grounding system, which in turn comprises at least one conductor and/or electrode according to the present invention, also falls within the scope of this invention.

### Lightning Rod Lead

The conductors and/or electrodes in question are also used as part of a lightning rod lead, manufactured with the parts in question, and can be combined or not with a grounding system, which in turn comprises at least one conductor and/or electrode according to the present invention.

By or that this more complex system falls within the spirit of the present invention.

### Neutral Wire Lead and Neutral Wire for Underground Distribution Lines

They can also used in neutral wire leads. For this, the carbon steel part is formed as a coated carbon steel wire in accordance with the coating proposed by the present invention. So this kind of neutral wire lead also falls within the scope of the present invention.

### Pole Leads and Distribution Towers

The parts according to this invention can also be used in constructing pole leads and electrical power distribution towers.

### EXAMPLES

The following examples illustrate one of the preferential modes for carrying out the present invention, which should be considered as merely illustrative and should not be considered as a limitation for the present invention.

### Example 1

### Data on the Zinc Layer or Coating

TABLE 2
Data from the outer zinc layer, in carbon steel strips.

| Layer | Designation | g/m² | Thickness μm |
|---|---|---|---|
| G60 | Z180 | 180 | 25 |
| G90 | Z275 | 275 | 39 |
| G100 | Z305 | 3G5 | 43 |
| G115 | Z350 | 350 | 49 |
| G140 | Z450 | 450 | 63 |

In accordance with the data of Table 2, the strips chosen for this invention were those of up to a G90 layer, which were found to have a viable relationship between the market and functionality for purposes of the carbon steel strips according to the present invention. However, the invention can be carried out with other densities and thicknesses, which also fall within the scope of the present invention. So the preferred thickness of the zinc coating according to the present invention is 18-40 μm.

### Example 2

### Behavior of Gauges of the Carbon Steel Strips with the G90 Zinc Layer

In order to know what was the best combination of gauge of the carbon steel part and the zinc coating, various calibers of 0.02% carbon steel strips were tested. The results are shown in Table 3.

As can be seen in Table 3, of the steel strips tested, the 16-caliber strip is preferred, since its thickness is sufficient to withstand pressures around 12 kg/m², which is sufficient to be useful for electrodes that receive and send electrical power.

### Example 3

### Manufacture of the Coated Carbon Steel Part According to the Present Invention

Strips of 0.02% carbon EDDS (Extra Deep Drawing Steel), 16 caliber, with a 20 μm zinc layer, were used.

Degrease the Steel Metal Strips by Immersion.

A mild steel tank was filled to 2/3 of its volume with water. Then 7.5% (75 mg/L) of EMPREP SP 68® was slowly added with constant stirring. Water was added to fill the tank to its operating level, and it was heated to 60° C. The strips were dipped for 3 min.

TABLE 3
Characteristics of the 0.02% carbon steel strips with a zinc coating.

| | Thickness | Weight kg/m² | | | | | Z275 | |
|---|---|---|---|---|---|---|---|---|
| Gauge | mm | Z450 | Z350 | Z305 | Z275 | Z180 | kg/m | kg*50 |
| 8 | 4.18 | 33.2 | 33.1 | 33.1 | 33.1 | 33.0 | 0.00 | 0 |
| 10 | 3.42 | 27.3 | 27.2 | 26.9 | 27.1 | 27.0 | 0.00 | 0 |
| 12 | 2.66 | 21.3 | 21.2 | 20.9 | 21.1 | 21.0 | 0.00 | 0 |
| 13 | 2.28 | 18.3 | 18.2 | 17.9 | 18.2 | 18.1 | 0.00 | 0 |
| 14 | 1.90 | 15.3 | 15.2 | 14.9 | 15.2 | 15.1 | 0.00 | 0 |
| 15 | 1.71 | 13.9 | 13.8 | 13.5 | 13.7 | 13.6 | 0.00 | 0 |
| 16 | 1.52 | 12.4 | 12.3 | 12.0 | 12.2 | 12.1 | 0.00 | 0 |
| 18 | 1.21 | 10.0 | 9.9 | 9.6 | 9.8 | 9.7 | 0.00 | 0 |
| 20 | 0.91 | 7.6 | 7.5 | 7.2 | 7.4 | 7.3 | 0.00 | 0 |
| 22 | 0.78 | 6.4 | 6.3 | 6.0 | 6.2 | 6.1 | 0.00 | 0 |
| 24 | 0.61 | 5.2 | 5.1 | 4.8 | 5.0 | 4.9 | 0.00 | 0 |
| 26 | 0.48 | 4.0 | 3.9 | 3.8 | 3.8 | 3.8 | 0.00 | 0 |
| 28 | 0.38 | 3.4 | 3.3 | 3.0 | 3.2 | 3.1 | 0.00 | 0 |
| 29 | 0.34 | 3.1 | 3.0 | 2.7 | 3.0 | 2.9 | 0.00 | 0 |
| 30 | 0.31 | 2.8 | 2.7 | 2.4 | 2.7 | 2.6 | 0.00 | 0 |

Degrease by Spraying the Metal Strips with a Mixture of Plain Water and an Alkaline Cleaner.

The strips were spray rinsed with 20 g/L of EMPREP SP 68® at 55° C. for a sufficient length of time to clean off loosened oil and grease residues.

Spray Rinse the Strips with just Plain Water.

The strips were rinsed with water to remove loosened oil and grease residues as well as all the alkalinity caused by the alkaline cleaner.

Activation of the Metal Strips

The strips were activated by immersion in a mixture containing 30 g/L of Actane® 73 at room temperature for 2 min. With this neutralization, the steel strips did not experience wear by the subsequent copper and tin coatings, since the Actane 73® salt produces a corrugated outer surface on the galvanized steel part, which facilitates the adhesion of the copper particles.

Spray Rinse the Strips with just Plain Water.

The strips were rinsed with plain water in order to remove the activator residues.

Copper-Plating of the Metal Strips by Electrolysis

An aqueous mixture of 60 g/L of sodium cyanide, 45 g/L of copper cyanide, and 20 g/L of Rocheltex® salt, at 45° C., pH of 11.5, for 12 min, was used to achieve a layer 10 μm thick to give the strips greater corrosion resistance and a better finish, since the tin adheres better.

The Copper-Plated Steel Strips are Subjected to Two Continuous Spray Rinses with “Plain Raw” Water.

The galvanized and copper-plated carbon steel strips were subjected to two continuous spray rinses with “plain raw” (unprocessed) water at room temperature for a sufficient length of time to clean off copper residues.

Activate the Surface of the Copper-Plated Steel Strips.

The strips are immersed in a mixture of Actane 73® in a quantity of 30 g/L, at room temperature for 2 min, in order to “open” the copper molecules and thus increase the adherence of the tin.

The Strips are Subjected to a Spray Rinse with “Plain Raw ” Water.

The strips were subjected to a spray rinse with “plain raw” (unprocessed) water at room temperature for a sufficient length of time to clean off Actane 73® residues.

Tin-Plating of the Previously Copper-Plated Carbon Steel Strips

An acid tin-plating mixture comprising 22.5 g/L of tin sulfate, 10 v/v % of sulfuric acid, 3 v/v % of Solderex TB-A, and 0.5% of Solderex TB-B was used, at 21° C., to a cathodic current density of 2 ASD (drum) and 1 ASD (barrel, with an anode current density of 1 ASD, for 13 min, to deposit a tin layer 10 μm thick on the outer surface of the copper-plated steel part.

Rinse the Tin-Plated Metal Strips with Deionized Water.

Then rinse the tin-plated metal strips with deionized water at room temperature until excess tin particles that have not adhered to the strip are eliminated.

Activate the Tin of the Metal Strips.

A mixture of 30 g/L of Actane 73® at room temperature was used for 2 min to activate the tin and to prevent the part from staining and acquiring greater shine.

Rinse the Parts with Plain Water.

The parts were spray rinsed with normal “plain raw” (unprocessed) water at room temperature for a sufficient length of time to clean off alkaline cleaner residues.

Seal the Tin-Plated Metal Strips with Solderex TB-B®.

The metal strips, tin-plated and clean, were rinsed in an aqueous solution containing Solderex TB-B® at a concentration of 0.5 v/v %, at a temperature of 21° C., for 20 min, to help the acid tin components not to leave yellow spots, by filling in the holes, pores, micropores, cracks, etc., in the outer tin layer. The thickness of this layer was not greater than 1 μm. With this immersion rinsing, an outer layer was added to tin-plated metal parts, which is like a seal that helps reduce corrosion to these parts, resulting in greater durability.

Drying of the Tin-Plated Metal Strips

Finally, the tin-plated strips were subjected to air drying at room temperature in order to dry them and prepare them for packaging or direct use.

### Example 4

### Equipment Proposed for Performing the Procedures of the Previous Two Examples

To perform the conditioning and tin-plating procedures described in this invention, equipment was used in a horizontal continuous-line, so-called “rail-to-rail,” to perform both procedures continuously, so that the metal strips are processed in a horizontal orientation but their width in a vertical position.

### Example 5

### Corrosion Tests to which Different Carbon Steel Strips were Subjected, Among them, that According to the Present Invention

The carbon steel strips coated with zinc, copper, tin, and sealant according to the present invention were subjected to corrosion tests to determine whether it is suitable to coat them, in order to increase their useful life by corrosion when used as electrodes in ground networks. So, different types of carbon steel strips were compared. The corrosion rate in h was evaluated. The treatments are shown in Table 4, and the corrosion results for each treatment can be seen in the attached figures, before (0 h) and after (200 h).

To this end, strips from the different treatments were kept in a salt spray chamber, according to Table 4, for 200 h, and photographs were taken at zero hour (before) and 200 h (after).

TABLE 4
Types of carbon steel strips that were
kept in a salt spray chamber for 200 h.

| Treatment | Description | FIG. |
|---|---|---|
| 1 | Carbon steel (AC) | 1 |
| 2 | AC + wax layer (Nox-Rust ®) | 2 |
| 3 | AC + cold galvanizing paint (CRC ®) | 3 |
| 4 | AC + CRC ® + Nox-Rust ® | 4 |
| 5 | AC + cold galvanizing paint Galvanite ® | 5 |
| 8 | AC + Galvanite ® + Nox-Rust ® | 6 |
| 7 | Galvanized carbon steel (ACG) | 7 |
| 8 | ACG + Nox-Rust ® | 8 |
| 9 | ACG + tin | 9 |
| 10 | ACG + Nox-Rust ® + tin | 10 |
| 11 | EDDS with 0.02% C | 11 |
| 12 | EDDS with 0.02% C + Nox-Rust ® | 12 |
| 13 | EDDS with 0.02% C + tin | 13 |
| 14 | EDDS with 0.02% C + zinc + copper + tin + sealant | 14 |
| | (Solderex TB-B ®) | |

EDDS—Extra Deep Drawing Steel.

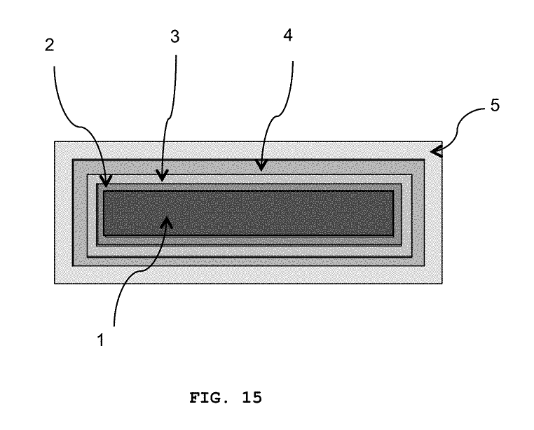

According to the photographs illustrated in the figures included in this invention, it was noted that treatment 14 showed the least corrosion after 200 h in the salt spray chamber (see FIG. 14). This treatment 14 corresponded to the galvanized, copper-plated, tin-plated and sealed carbon steel strips that are the object of the present invention. Therefore, the strip proposed in this invention is a good option to resist environmental corrosion without affecting its electrical conductivity. So it can be used as electrodes that receive and conduct electrical power.

Therefore, externally applying tin to carbon steel strips gives them an advantage over corrosion, causing strips coated with the coating according to the present invention to have all the abovementioned advantages.

### Example 6

### Evidence of the Short Circuit Capacity of the Coated Carbon Steel Parts

Three coated 0.02% carbon steel strips according to the present invention were used and were submitted to short circuit capacity tests of 8 cycles in the Equipment and Materials Test Laboratory (LAPEM) of the Federal Electricity Commission (CFE).

TABLE 5
Result of the short circuit capacity tests of 8 cycles,
to learn the short circuit capabilities (kA) of the coated
carbon steel part according to the present invention.

| | | | | I² t | | | |
|---|---|---|---|---|---|---|---|
| Report | mm | Rcm(kA) | CP | (kA)² s | s | Obs | I |
| A | 38.1 | 39.81 | 60.67 | 50.06 | 0.137 | Not found | 13 |
| 8 | 25.4 | 25.30 | 36.94 | 23.75 | 0.1334 | Not found | 10 |
| C | 11.11 | 10.90 | 16.19 | 3.93 | 0.1334 | Not found | 10 |

The report used was K34220GS; mm=width of strip (mm); Rcm(kA)=Rcm(kA) current; CP=peak current; s=duration (s); Obs=Comments; I=number of attempts.

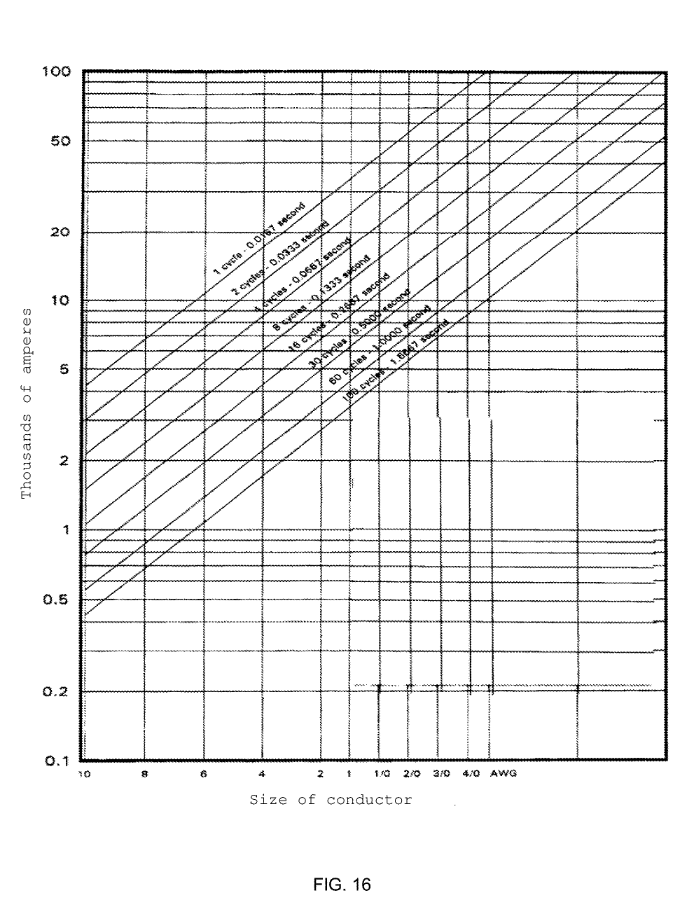

When crossing values (kA) with FIG. 16 corresponding to copper conductors, we discovered that we can get the equivalences that are shown in Table 6.

Taking as an example the size 11.11 mm, we came to the conclusion that it may replace by equivalency a 2 gauge AWG copper conductor, using it as the lead of a grounding system, and so obtain a great economic savings in addition to all the advantages already mentioned.

TABLE 6
Equivalence of conductor parts when crossing kA values.

| | |
|---|---|
| Size of steel strip + | Equivalent in copper |
| Zn + Cu + Su + sealant | conductor |

| | | | |
|---|---|---|---|
| 38.1 | mm | >250 | kcmil |
| 25.4 | mm | 3/0 | AWG |
| 11.11 | mm | >2 | AWG |

### Example 7

### Tests of the Surface Conductivity of the Coated Carbon Steel Part According to the Present Invention

Four carbon steel strips with multiple coating in accordance with the present invention were submitted to the CFE laboratories on January 15, 2015. For this, a surface conductivity meter was used, model FM-140XL, Centurion NDT brand. The results are shown in Table 7.

TABLE 7
Results of the conductivity of different samples of the coated
carbon steel part according to the present invention.

Samples

| Measurement | [symbol] | [symbol] | [symbol] | [symbol] |
|---|---|---|---|---|
| 1 | 28.7 | 28.8 | 28.7 | 28.6 |
| [symbol] | [symbol] | [symbol] | [symbol] | [symbol] |
| 3 | 28.7 | 28.6 | 28.6 | 28.6 |
| [symbol] | [symbol] | [symbol] | [symbol] | [symbol] |
| 5 | 28.2 | 28.6 | 28.9 | 28.7 |
| [symbol] | [symbol] | [symbol] | [symbol] | [symbol] |
| 7 | 28.8 | 28.8 | 28.7 | 28.7 |
| [symbol] | [symbol] | [symbol] | [symbol] | [symbol] |
| 9 | 28.6 | 28.5 | 28.6 | 28.3 |
| [symbol] | [symbol] | [symbol] | [symbol] | [symbol] |
| Mean | 28.62 | 28.66 | 28.66 | 28.59 |

[symbol]

indicates data missing or illegible when filed

The overall mean value was 28.68% IACS.

In report number K3421-2-2015 (Table 7), it is noted that, of 40 measurements, a mean value of surface conductivity of 28.63% IACS was obtained. This is an acceptable and competitive conductivity in comparison with existing products. Therefore, the part according to this invention is a material that complies with the specifications and international standards.

In accordance with what is described above, it will be apparent to a person skilled in the art that the modes of the coated metal parts and their production methods indicated above are presented only for illustrative purposes, since a person skilled in the art can make many variations to the same, like different materials, dimensions, and configurations, as long as they are designed in accordance with the principles of the present invention. As a consequence, the present invention includes all modes that a person skilled in the art can plan from the concepts contained in the present description, in accordance with the following claims.

1. A coated carbon steel part comprising:
i) a steel support material that contains 0.002-0.80% carbon;
ii) a zinc layer with a thickness of 18-40 μm covers the carbon steel support material; and
iii) a layer of copper nanoparticles with a thickness of 7-20 μm applied on the zinc layer.

2. The part of claim 1, where the part has a surface electrical conductivity of at least 28%.

3. The part of claim 1, wherein the zinc coating has a pressure resistance of 275 g/m2.

4. The part of claim 1, wherein the carbon steel support material is selected from the group consisting of: Extra Deep Drawing Steel (EDDS) and Deep Drawing Steel Type A and B (DDS).

5. The part of claim 4, where the carbon steel support material is Extra Deep Drawing Steel (EDDS).

6. The part of claim 1, wherein the layer of copper nanoparticles contains an aqueous mixture of 60 g/L of sodium cyanide, 45 g/L of copper cyanide, and 20 g/L of Rocheltex® salt, a liquid additive agent for electroplating solutions.

7. The part of claim 1, wherein the carbon steel part is formed as any one of or combination of strips, lines, rods, wires, wire rods, plates, foils, and bars.

8. The coated carbon steel part of claim 1, the coated carbon steel part when in a form of a strip is used as electrodes for electrical energy control systems, including grounding systems, lightning rod leads, pole leads, and distribution towers.

9. The coated carbon steel part of claim 8, wherein the coated carbon steel strip reduces by 60% the use of material for grounding electrodes, because they have greater contact surface than conventional cables or rods.

10. The coated carbon steel part of claim 8, wherein the coated carbon steel strip is welded with another similar strip without the use of clamps or connectors, which reduces by 10-30% the welding material and the installation time of a grounding line by 40-60%.

11. The coated carbon steel part of claim 7, wherein the coated carbon steel part when in a form of a steel line is used as conductors and/or electrodes for a neutral wire lead and a neutral wire for underground distribution lines.

12. The coated carbon steel part of claim 1, wherein the carbon steel part has an electrochemical potential that is compatible with both copper and aluminum, without galvanic couple and corrosion problems in the connections.

13. (canceled)

14. (canceled)

15. The coated carbon steel part in accordance with claim 1, wherein the part further includes:
i) a tin layer with a thickness of 7-20 μm applied on the copper layer and
ii) a sealing layer of a SOLDEREX TB-B(™) material, with a thickness no greater than 1 μm, applied on the tin layer.

16. The part of claim 1 wherein the tin layer has an aqueous solution of 18.75-37.5 g/L of sulfate, 9-10 v/v % of sulfuric acid, 2-4 v/v % of SOLDEREX TB-A(™), and 0.5-0.75 v/v % of SOLDEREX TB-B(™).

17. A conductor to carry or receive an electric current, comprise at least a coated carbon steel part comprising:
i) a steel support material that contains 0.002-0.80% carbon;
ii) a zinc layer with a thickness of 18-40 μm covers the carbon steel support material; and
iii) a layer of copper nanoparticles with a thickness of 7-20 μm applied on the zinc layer.

18. An electrode to carry or receive an electric current, comprise at least a coated carbon steel part comprising:
i) a steel support material that contains 0.002-0.80% carbon;
ii) a zinc layer with a thickness of 18-40 μm covers the carbon steel support material; and
iii) a layer of copper nanoparticles with a thickness of 7-20 μm applied on the zinc layer.

19. An electrical energy control system that comprises at least a conductor and/or an electrode to carry or receive an electric current, the electrode comprising at least a coated carbon steel part comprising:
i) a steel support material that contains 0.002-0.80% carbon;
ii) a zinc layer with a thickness of 18-40 μm covers the carbon steel support material; and
iii) a layer of copper nanoparticles with a thickness of 7-20 μm applied on the zinc layer.

20. A method to coat a carbon steel part with a coating of multiple layers of various materials comprising:
i) providing a steel support material that contains 0.002-0.80% carbon and is coated with a zinc layer with a thickness of 18-40 μm;
ii) degreasing the carbon steel support material now with the zinc coating by immersion, with a sodium hydroxide alkaline cleaner at a concentration of 5-10% at a temperature of 60-70° C. for 1-15 min;
iii) degreasing the support material by spraying with an alkaline cleaner with high detergency and low foaming, suitable for spraying and that can be used to clean steel, copper, brass, magnesium, aluminum, and other metals; at a concentration of 15-30 g/L, for a sufficient length of time to clean off loosened oils and grease residues;
iv) spray rinsing the support material with plain water at room temperature for a sufficient length of time to clean off loosened oil and grease residues and alkaline cleaner;
v) activating the support material by immersion in an acid salt solution at a concentration of 15-30 g/L for 1-5 min, to leave it free of ashes or any other dust contaminant;
vi) spray rinsing the metal parts with water for a sufficient length of time to clean off activator residues;
vii) applying a layer of copper nanoparticles with a thickness of 7-20 μm by electrolysis, with an aqueous mixture of 60 g/L of sodium cyanide, 45 g/L of copper cyanide, and a liquid additive agent for electroplating solutions, at 40-50° C., a pH of 11-12, for 10-15 min, 4-6 amp;
viii) spray rinsing twice with water the support material now with the zinc and copper layers for a sufficient length of time to clean off residues of the copper solution; and
ix) air drying the coated carbon steel part at room temperature, to prepare for packaging or direct use.

21. The method of claim 20, wherein the zinc coating has a pressure resistance of 275 g/m2.

22. The method of claim 20, wherein the carbon steel support material is selected from the group: Extra Deep Drawing Steel (EDDS) and Deep Drawing Steel Type A and B (DDS).

23. The method of claim 22, where the support material is carbon steel Extra Deep Drawing Steel (EDDS).

24. The method according to claim 20, wherein the galvanizing process to deposit the zinc layer is vacuum electroplating.

25. The method according to claim 20, wherein the carbon steel part is formed as any one or combination of strips, lines, rods, wires, wire rods, plates, foils, and bars.

26. The method according to claim 25, wherein the coated carbon steel part is a strip with a substantially rectangular cross-section.

27. The method according to claim 20 further comprising:
i) activating the surface of the copper layer through its immersion in an aqueous solution of a fluoride acid salt at a concentration of 30 g/L, for 1-5 min, to apply a layer of tins;
ii) spray rinsing with water to clean off the acid salt residues;
ii) electrolytically applying the tin layer on the copper layer by dipping the support material now coated with the zinc and copper layers in a solution that comprises: 18.75-37.5 g/L of tin sulfate, 9-10 v/v % of sulfuric acid, 2-4 v/v % of a commercial product known as Solderex IB-A®, and 0.5-0.75 v/v % of a commercial product known as Solderex TB-B®; at a temperature of 16-27° C., with a cathodic current density of 0.5-4 ASD (drum) and 0.5-3 ADS (barrel); with an anodic current density of 1-3 ASD; for an immersion time of 10-15 min, until a tin layer with a thickness of 7-20 μm is deposited;
iv) rinsing the metal part with deionized water to eliminate those tin particles that have not yet adhered;
v) activating the now tin-plated parts by dipping in a fluoride acid salt solution for 1-5 min to neutralize the action of the tin and prevent the tin layer from staining;
vi) spray rinsing the parts with water for a sufficient length of time to clean off acid salt residues;
vii) adding a sealing layer on the tin layer by immersion of the coated part in an aqueous solution containing the commercial product Solderex TB-B® at a concentration of 0.5-0.75 v/v %, at a temperature of 21-60° C., for 15-60 min, until achieving a sealant thickness of no more than 1 μm; and
viii) air drying the coated carbon steel part at room temperature to prepare for packaging or direct use.

28. The method according to claim 20 further comprising subjecting the steel support material to a prior galvanization process to apply the first zinc layer with a thickness of 18-40 pm, when this support material lacks the zinc coating.

29. (canceled)
